(19) United States
(12) Patent Application Publication
(10) Pub. No.: US 2004/0247927 A1
(43) Pub. Date: Dec. 9, 2004

(54) Method of producing seamless, multi-layer, bonded, metallic, laminate strips or coils of arbitrarily long length

(76) Inventor: Douglas L. Kurz, Sands Point, NY (US)

Correspondence Address: KENYON & KENYON, ONE BROADWAY, NEW YORK, NY, 10004, US

(21) Appl. No.: 10/456,420

(22) Filed: Jun. 6, 2003

(51) Int. Cl. B32B 15/04

(52) U.S. Cl. 428/608; 428/613

(57) ABSTRACT

A method of producing seamless, multi-layer, bonded, metallic laminate materials of arbitrarily long length is provided. The method includes affixing together, for example via continuous resistance welding, and sintering at least two continuous, metallic layers to form a continuous laminate strip material.

### FIELD OF THE INVENTION

The present invention relates to a method of producing multi-layer, bonded, laminate materials in continuous seamless coils of arbitrarily long length. Such continuous laminate strip materials include sintered, multi-layer woven wire mesh laminates and related materials, which may be used, for example, in filtration and other industrial, aerospace and medical applications.

### BACKGROUND OF THE INVENTION

The production of diffusion-bonded laminate media is known in the art. Typically, such materials are manufactured in discrete rectangular panels of finite and limited length. Such laminate panels may consist of a plurality of layers of one or more of the following classes of materials: foraminate materials such as woven wire mesh screens; expanded metals; perforated metals; solid metal foils or sheets; photo-etched metal foils; metal fibers; mats or webs of randomly laid metal fibers; pre-alloyed or blended metal powders; metal shavings or slivers; metal honeycomb structures; and punched, drilled, cut, or otherwise processed sheets of the above enumerated types.

While these classes of materials are most frequently encountered in austenitic stainless steel alloys, many other metals or alloys may also be employed. Additionally, the individual layers may be all of the same base metal or alloy, or they may consist of dissimilar metals or alloys. Some examples of diffusion-bonded laminate media include the following: a layer of fine screen bonded to a support layer such as a coarse heavy screen or a perforated metal sheet; layers of metal fiber web of progressively finer fiber sizes bonded together and to a foraminate support screen; multiple layers of identical screens laid up in different angular orientations and bonded together and compressed to a desired permeability or pore size; layers of metal powder particles sintered together to produce a strong but porous metal sheet; a filter plate comprising a surface protection layer, a filter layer, a flow distribution layer, and a structural support of two or more layers, wherein the filter layer may be a woven wire mesh or a layer of graded porosity fiber metal felt; a cathode plate for an electrochemical reactor, comprising a perforated metal plate, many layers of fiber metal felt, and a wire mesh protective layer; a filter medium comprising a layer of 325×2300 twilled Dutch weave woven wire mesh with an integrally sintered upstream layer of −500 mesh metal powder bonded to the surface; a sintered stack of multiple layers of wire mesh alternating with solid stainless steel foil used in a heat exchange application; a bipolar plate assembly comprising photo-etched or otherwise cut metal foil with fine wire mesh for use in a fuel cell application; a composite of photo-etched metal foil with perforated metal; a laminate of one or two layers of plain square weave wire mesh and thin-gauge metal foil; and a laminate of plain Dutch weave filter mesh and two layers of plain square weave support meshes to provide drainage and mechanical strength.

The known methods of diffusion bonding laminates are primarily batch processes, although some continuous processes of limited utility are also known in the art. In the typical batch process, a group of rectangular panels of the same size are processed simultaneously. First, the component layers of each laminate panel are laid up in the proper sequence, and affixed by some local bonding method, such as spot welding, at the corners or edges. Then, the said affixed panels are stacked up with a layer of some suitable means of separation between successive panels. The stack is typically compressed by applied force, such as by the application of mechanical pressure via a hydraulic ram and platen normal to the plane of the laminate panels. In another known batch process, the stack of laminate panels is encased in a steel or other envelope that is then evacuated to induce an applied pressure exerted by the ambient atmosphere outside the envelope. Once so prepared, the stack is then placed into a batch furnace in which the stack typically remains within the enclosure of the furnace throughout the heating cycle. In still another method, a pillow above the stack is inflated with gas once the stack is placed in a vacuum furnace. The gas-filled pillow is constrained by a graphite platen above, and thus exerts pressure on the stack below.

The heated zone of the furnace in the known batch processes may preferably be maintained at accurately controlled and uniform temperatures, and contains a controlled non-oxidizing atmosphere or vacuum. By the proper application of heat and pressure in this controlled environment of the furnace, it is possible to produce well-bonded laminate panels that are nonetheless clean, bright, and are not metallurgically impaired in any way. However, the laminate panels manufactured in this fashion are necessarily limited in length by the size of the furnace hot zone.

Other methods have been employed in the art to produce a limited subclass of diffusion-bonded materials in long-length seamless coils or rolls. For example, U.S. Pat. No. 6,306,336 to Hrezo et al. disclose an apparatus and method for continuous sintering of metal fiber web using a continuous open-ended furnace. In another such method, various layers of random-laid drawn and chopped metal fiber web, optionally with the addition of one or more layers of woven wire mesh included on one or both sides, are sinter bonded by rolling or winding said layers up onto a core, while interleaving a suitable separation medium. The wound coil so created, which resembles in principle a “jelly roll,” is then put into a batch furnace, such as a hydrogen-atmosphere bell furnace, in which a suitable cycle of heating and cooling is employed in order to effect the sintering of the metal fibers and mesh layers into an integral structure. Such materials are produced commercially, and can be further fabricated into filter elements.

In another such method, several component layers of woven wire mesh are simultaneously wound onto a core suitable for sintering. As above, a suitable separation medium must be interleaved. The resulting coil is then put into a batch furnace, such as a hydrogen-atmosphere bell furnace, and sintered.

Such known winding and sintering processes have had limited success with meshes, as the lack of longitudinal tension on the strip, and the lack of radially applied pressure normal to the plane of the strip, limit the effectiveness of the sintering. With severe winding tension, heavier meshes may be laminated, but there has been no demonstration of a secure and repeatable sinter-bond on a full range of materials. Furthermore, such tensioning might be difficult or impossible on some materials, or might stretch, damage or otherwise change the properties of the component materials. Conversely, without such tension, a “soft sintered” result is the best that can be obtained. In the case of metal fibers, “soft sintering” without compression may provide a useful product of high void volume and permeability. However, in the case of wire mesh laminates, “soft sintering” results in improperly and inadequately bonded laminate.

Furthermore, the apparatuses for winding the meshes in this fashion are known in the art. For example, a similar apparatus has also been used to make air bag “windings” for automotive deployment. Although this design of air bags may now be obsolete, the typical air bag winding traditionally comprised several layers of woven wire mesh and an interleaved refractory material strip such as FIBERFRAX® alumina fiber “paper.” The preparation of this winding is virtually identical to the preparation described above for sintering, except that the “winding” for sintering could have a substantially longer linear length (or number of circumferential winds). In sum, the apparatus used for making air bag windings may also be used for winding meshes in preparation for sintering.

In another known method, metal fiber media or single layers of fine woven wire mesh have been fed on a continuous basis through an open-ended sintering oven, which may or may not have a moving conveyor belt or other means of conveying the material. Alternatively, the material may hang in the furnace in a catenary configuration, whose linear motion through the furnace is driven by a wind-up mechanism at the furnace exit. Such an oven typically contains an inert or reducing gaseous atmosphere.

In a similar method known in the art, multiple strips of media may be fed through such an oven simultaneously if a suitable separation medium is interposed between the successive articles. Again, this method may be successfully employed to laminate or fuse certain materials which are more easily sintered or diffusion bonded, such as fine metal fibers; however, other materials that require more extreme process conditions (such as higher temperatures, higher pressures, or longer times at temperature) in order to develop an acceptably secure diffusion bond are typically not able to be laminated properly according to this method.

U.S. Pat. No. 5,679,441 to Saelens et al. discloses a process for continuously manufacturing a porous laminate, wherein a metal wire mesh and a metal non-woven fiber web superposed on the wire mesh are passed between rotating pressure rollers having differing electrical potentials. The rotating pressure rollers are equipped to provide a discharge of electrical current through the metal wire mesh and the metal non-woven fiber web superposed on the wire mesh so as to, according to Saelens et al., “sinter” the fibers of the non-woven web together at points of mutual contact and to the wire mesh. Again, such a process may be successfully employed to laminate or fuse certain materials that are susceptible to this process; however, other materials may require more extreme process conditions in order to develop an acceptably secure bond of any kind, and are thus typically not able to be laminated properly according to this process.

Metallurgically bonded laminate materials, such as the types described herein, find a very wide range of applications including, but not limited to: liquid filtration, gas filtration, liquid-solid separation, gas-solid separation, gas-liquid separation; coalescing, demisting, and de-dusting; process filtration in the chemical, pharmaceutical, petrochemical, polymer and food and beverage industries; fluidized beds; fluidization of bulk dry powders for conveying, transport or discharge; controlled permeability media used for acoustic attenuation, transpiration or sublimation cooling, de-icing systems, or flow snubbing; spargers; film rollers; medical implants; orthodontic and dental devices; sand control media deployed down-hole as part of well completion in the production of oil and gas; flame arresters; architectural and decorative components; fractal surfaces for infrared suppression, inducement of laminar flow, ion traps, and bonding substrates; heat sinks; wicking devices; flow field media and membrane support media in bipolar plate assemblies for fuel cell applications; laminar flow fiber quench media; spinpacks and screenpacks used in polymer fiber production; as well as many others. As used herein, the phrase “metallurgical bond” refers to any bond formed without the addition of any other substance or bonding agent such as adhesive, glue, solder, braze, filler metal, etc.

Such laminate materials are often fabricated into component parts such as, for example, blanked or cut discs or shapes, pleated strips, simple tubes (axially formed and longitudinally seam welded, as well as spiral wound and spiral welded) with or without end fittings or other welded hardware, and other configurations.

However, as described above, current diffusion-bonding practices are in many cases limited to the production of flat rectangular sheets of finite and relatively short length (typically not greater than ninety-six (96) inches). This often necessitates extra handling, such as manually feeding short strips into a punch press one at a time, or extra processing, such as sequentially butt-welding a series of said short strips or finite-length panels end-to-end to create a longer strip or panel that is nonetheless not seamless. Unfortunately, in many applications, such weld seams are either detrimental or even completely unacceptable.

Thus, there is a need in the art for a method of producing metallurgically bonded metallic laminate strips or coils of arbitrarily long length, such that the metallic materials could be fed continuously into various machinery, such as, for example, punch presses, pleaters, progressive die tube formers, spiral winding and welding equipment, and the like.

### SUMMARY OF THE INVENTION

An embodiment of the present invention is directed to a method of producing a continuous laminate strip material. The method comprises affixing together at least two layers to form a pre-bonded laminate material, wherein each of the layers comprises a continuous metallic material, and at least one of the layers is foraminate and permeable. The pre-bonded laminate material is then sintered to form the continuous laminate strip material.

A further embodiment of the present invention is directed to a continuous laminate strip material comprising at least one layer comprising a first continuous metallic material, wherein the at least one layer is foraminate and permeable; and at least one additional layer comprising a second continuous metallic material. In this embodiment, the at least one layer and the at least one additional layer are bonded together via continuous resistance welding, sintering, or a combination of the two.

In preferred embodiments of the invention, a combination of continuous resistance welding and sintering is employed, providing a variety of benefits for the resulting continuous laminate strip material.

### BRIEF DESCRIPTION OF THE DRAWINGS

FIG. 1 shows a schematic representation of an embodiment of the pre-bonding process according to the present invention.

FIG. 2 shows a schematic representation of another embodiment of the pre-bonding process according to the present invention.

FIG. 3 shows a schematic representation of an embodiment of the sintering or diffusion bonding process according to the present invention.

FIG. 4 shows a schematic representation of another embodiment of the sintering or diffusion bonding process according to the present invention.

FIG. 5 shows a schematic representation of an embodiment of the invention wherein a pre-bonded laminate material is wound up onto a core with a suitable separator material interleaved therein to form a coil.

FIG. 6 shows a more detailed schematic representation of an embodiment of the coil shown in FIG. 5.

The reference numbers used herein to describe each of these Figures are to be interpreted consistently throughout the specification, as common numbers are to be given a common meaning throughout all of the Figures.

### DETAILED DESCRIPTION

The present invention will be described with reference to the illustrative embodiments in the following processes.

The present invention relates to methods of producing a laminate material including two or more layers of metallic materials. In a preferred embodiment of the method of the invention, the process of lamination is accomplished by an appropriate combination of a “pre-bonding” procedure, such as continuous resistance welding, and a suitable high-temperature diffusion bonding process (e.g., sintering). More particularly, the present invention relates to a method of manufacturing such laminate materials in continuous strip form, or in coils of arbitrarily long length, which may be unwound to yield a long flat strip. Furthermore, the present invention relates to the laminate materials produced by the methods described herein, and the broad class of porous and non-porous media which they represent.

The continuous laminate strip material of the present invention comprises two or more layers of metallic materials, wherein at least one layer is foraminate and permeable. Suitable layers of metallic materials include, but are not limited to: woven wire meshes or screens (including plain or twilled weaves; square, rectangular or Dutch weaves; and other weave styles); metal foils (including solid, die cut, laser etched, photo-etched, perforated, expanded, laser drilled, wire electrical discharge machined, or otherwise treated); metal sheets, strips or plates (either solid or machined, drilled, perforated, expanded, punched, laser cut or drilled, water jet cut, wire electrical discharge machined, or otherwise treated); metal fiber webs; pre-sintered metal fiber media; sintered porous powder metal sheets; composites of metal meshes, powders and/or fibers; or other metallic structures. For example, representative embodiments of the layers include two or more layers of woven wire mesh, and one or more layers of a metal foil or a metal strip (which may itself be expanded, lanced, punched, drilled, photo-etched, die cut, or otherwise perforated or foraminate) combined with one or more layers of woven wire mesh.

In addition, according to the present invention, the two or more layers of metallic materials may be comprised of the same or different metallic materials. Preferred metallic materials include: austenitic stainless steels, such as American Iron & Steel Institute (AISI) types 304, 304L, 316, 316L, or 347 stainless steels; nickel and its alloys, such as INCONEL® 600, MONEL® 400, and certain HASTELLOY® alloys; oxygen-free high conductivity copper; phosphor bronze; and other alloys, particularly those of iron, cobalt, chromium, copper, aluminum or titanium, whose composition does not contain (1) excessive amounts of aluminum or titanium (which tend to form oxides difficult to reduce and are therefore unfavorable to the process of diffusion-bonding), (2) excessive potential contaminants such as sulfur and phosphorus, and (3) volatile elements with high vapor pressures and/or low melting points such as lead, cadmium and zinc. Other suitable metallic materials for use in the invention include: semi-austenitic stainless steel, such as 17-7 PH; ferritic stainless steels, such as AISI type 430; AISI type 321 or 316Ti stainless steels; oxygen-bearing coppers; brasses and bronzes; titanium; and other metals and metal alloys.

As used herein, when referring to a product or a laminate material, the word “continuous” denotes a seamless strip of arbitrarily long length which may be manufactured or employed either as a flat strip, or in a coil form for subsequent unwinding. The phrase “arbitrarily long length” denotes being longer than typically achieved by processing discrete rectangular sheets in a batch furnace. For example, the limit on commercially available rectangular sheets is typically 96 inches; therefore, any seamless strip longer than 96 inches would have to be produced by a different process, such as the method of the present invention (i.e., it would be of an arbitrarily long length). In addition, as used herein, when referring to a process or a method of manufacturing, the word “continuous” is to be given its ordinary meaning as would be understood by one of ordinary skill in the art. For example, continuous processes include both (1) processes wherein material is fed linearly with constant or intermittent movement through a processing unit, such as for example, a continuous open-ended strip sintering furnace; as well as (2) processes wherein material is fed up an incline, across a level plateau, then down an incline with constant or intermittent movement through a processing unit, such as for example, a humpback furnace. The present invention relates to the manufacture of continuous laminate materials, which may be manufactured by both continuous and non-continuous (e.g., “batch”) processes.

An advantage of the present invention is that the constraint on laminate sheet lengths is largely eliminated, which allows for a much broader application of the laminate sheets produced in accordance with the present invention. Seamless, long-length laminate strip materials may be used in the same broad spectrum of applications that is currently served by laminate panels of limited length. However, the seamless, long-length laminate strip materials produced in accordance with the present invention should find further and more useful and extensive application in industry by virtue of their long length. For example, in any high-volume manufacturing operation, such as stamping, it is preferable to have materials fed from continuous coils, rather than in discrete panels. Thus, the seamless, long-length laminate strip materials of the present invention would be preferred in such high-volume manufacturing operations. Furthermore, the cost of manufacturing and using continuous materials may be more attractive than that of panels of limited length, which may in turn open up a broader range of applications for such materials, such as for example, automotive applications such as fuel cell components.

Additionally, the availability of the seamless, long-length laminate strip materials produced in accordance with the present invention may enable the production of previously unavailable articles, such as tubular constructs of diffusion-bonded materials, which are spiral wound and welded (or longitudinally formed and welded) in arbitrarily long lengths. Such articles could find application in, for example, sand control and filtration devices employed in oil and natural gas wells, either as long unitary tubes, or as materials that are fed continuously downhole and “expanded” in place.

In one embodiment of the invention, a continuous method is provided for producing a continuous laminate strip material. The layers of the desired continuous laminate material begin as individual feedstock coils of the various component layers such as, for example, metal foil, woven wire mesh, and others. Such coils may be slit to a desired width, and may be pre-treated in various ways prior to their use in the method of the invention. For example, in the case of woven wire mesh, two such desirable pre-treatments are: (1) cleaning or degreasing, to remove any lubricants on the wire surfaces that might impart contamination during subsequent treatment; and (2) calendering, which is a method of compressing and flattening a material by passing it through a pair of heavy rotating rolls which are maintained at a fixed roll gap or at a positive pressure so as to impart compressive force normal to the plane of the material. Woven wire meshes or other component materials in continuous coil form may also be, for example, tensioned, straightened, flattened, annealed, heat treated, stretcher-leveled, trimmed, plated, coated or otherwise treated prior to being employed in the method of the present invention.

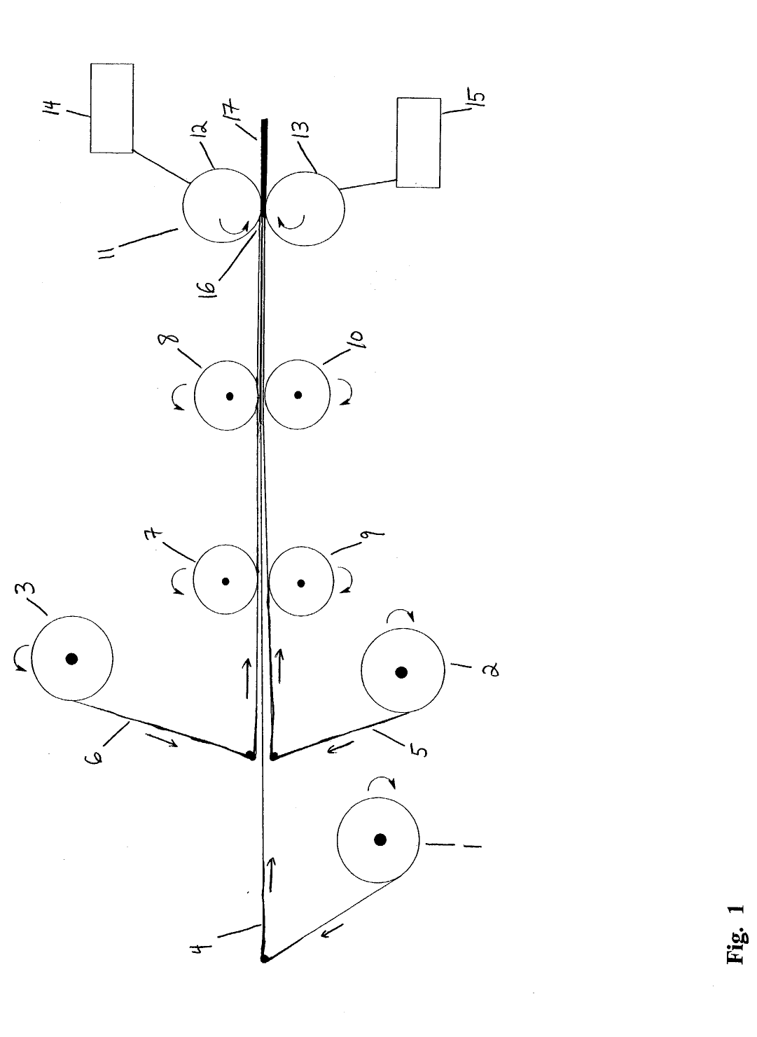

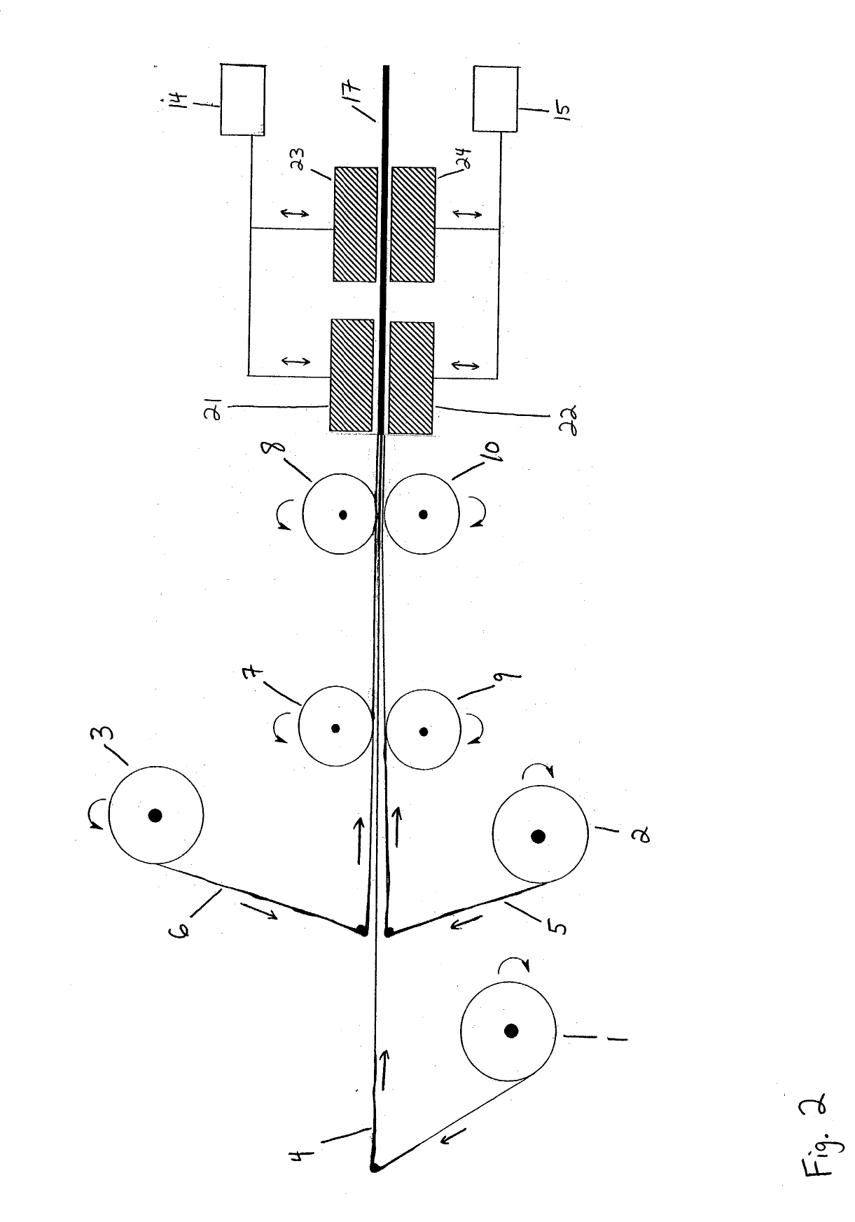

In an example of this embodiment of the invention, as depicted in FIG. 1, the various coils of material 4,5,6 that represent the component layers of the desired continuous laminate strip material are fed from individual uncoilers or feed rolls 1,2,3, and are guided simultaneously by guide rolls 7,8,9,10 into a device 11 resembling a two-high calender mill. The arrows shown in FIG. 1, as well as those in FIGS. 2-6, refer to the direction of rotation of the roll or coil, or the direction of movement of the material or component. The calender rolls 12,13 of the device 11 are suitably designed to also function as a continuous resistance welding (“CRW”) device. For example, the rolls 12,13 may be made of high-purity high-conductivity copper, or a suitable alloy thereof, and may be water-cooled. One roll 12 is fed by a controllable power supply 14, while the other roll 13 is connected to an electrical ground 15. Preferably during this process, the area 16 wherein the electrical discharge occurs is flooded with a suitable inert or reducing gas, such as argon, helium, or a mixture such as 95% argon/5% hydrogen, which acts as a shielding gas. This shielding gas helps to prevent the formation of surface oxidation on the various component layer materials 4,5,6, which may thereby enhance the bonding between the component layer materials 4,5,6.

Thus, as shown in FIG. 1, as the component layer materials 4,5,6 pass through the device 11, a combination of continuous resistance welding (“CRW”) and calendering occurs. The degree of welding can be determined by the electric current applied (via roll 12) and the linear speed of the material (which corresponds to the rotational velocity of the feed rolls 1,2,3). The degree of calendering can be controlled by adjusting the fixed gap between the rolls 12,13, and/or by imparting additional or varying pressure on the component layer materials 4,5,6 via the roll mechanism.

As the component layer materials 4,5,6 pass through the contact area 16 between the rolls 12,13 of the device 11, both pressure and welding current are applied over this contact area 16. Thus, the component layer materials 4,5,6 become affixed together via the combination of CRW and calendering, thereby forming a pre-bonded laminate material 17. The affixing together is not achieved solely via a “sinter bond” (i.e., a metallurgical bond formed by the application of heat, but generally at temperatures below the melting point of the material), nor is it achieved solely via a “diffusion bond” (i.e., a metallurgical bond formed by the application of sufficient heat and/or pressure to cause molecular or atomic diffusion across tangential metal surfaces). Instead, the affixing together is achieved via a simultaneous application of a pressure and a flow of electrical current to the two or more component layers, represented by component layer materials 4,5,6 in FIG. 1, to produce a continuous resistance weld across substantially all of the surface area of the resulting pre-bonded laminate material 17. That is, via the combination of CRW and calendering, the two or more component layers, represented by component layer materials 4,5,6 in FIG. 1, are affixed together to form a pre-bonded laminate material 17. As used herein, the phrase “pre-bonded laminate material” refers to the laminate material formed by the affixing together of the two or more component layers, preferably via a combination of CRW and calendering. Likewise, the term “pre-bonding” refers to the method step of affixing together the two or more component layers, preferably via a combination of CRW and calendering.

The correct combination of CRW and calendering to be applied to the two or more component layers is dependent upon the characteristics of the component layers. For example, some materials may require a higher current and a greater degree of compressive force or pressure in order to develop a secure bond between the component layers, while other materials may require a low welding current only, with little or no calendering pressure required to develop a secure bond. Suitable operating parameters for this embodiment of the method of the invention include: an ambient room temperature of about 60°-90° F.; an applied pressure of about 80-400 psi; a current density of about 10,000-30,000 amperes per square inch; a difference in electrical potential of about 2-6 volts; a linear speed of component layer materials and pre-bonded laminate material through the combination process of about 6-12 inches per minute; and a diameter of copper electrode rolls 12,13, when used in this combination process, of about 3-8 inches. These suitable operating parameters are exemplary ranges only, and the specific parameters for a given combination process of CRW and calendering will depend upon the composition of each component layer material.

In a further embodiment of the method of the present invention as depicted in FIG. 2, a pre-bonded, continuous laminate material 17 is produced via a linearly indexed process of intermittent motion. According to this embodiment, the component layer materials 4,5,6 are indexed (i.e., moved forward by a fixed interval of distance) through at least one pair of platens or flat bars 21,22, in lieu of the rotating rolls 12,13 described in the above-mentioned embodiment depicted in FIG. 1. As can be seen in FIG. 2, the embodiment of the invention depicted therein has two pairs of platens or flat bars 21,22 and 23,24. Once the linear “indexed” motion stops, the pair of platens or flat bars 21,22 and/or 23,24 close, and both pressure and welding current are applied over the flat planar area between the platens or flat bars 21,22 and/or 23,24 as previously described in relation to FIG. 1. The component layer materials 4,5,6 thereby become affixed together to form a pre-bonded laminate material 17 via this combination of CRW and calendering. After a suitable application of sufficient pressure and welding current, the pair of platens or flat bars 21,22 and/or 23,24 open, the component layer materials 4,5,6 “index” forward again, and the pre-bonding process is repeated on an adjacent section of the component layer materials 4,5,6. Thus, after numerous iterations of such pre-bonding and “indexing,” a pre-bonded, continuous laminate material 17 is thereby formed. As would be understood by one of ordinary skill in the art, the additional pair(s) of platens or flat bars, 23,24 in FIG. 2, can be positioned and employed in such a way as to open and close together with, or alternatively to, the first pair of platens or flat bars, 21,22 in FIG. 2, and all such processes are within the scope of the present invention.

Suitable operating parameters for the exemplary embodiment of the method of the invention depicted in FIG. 2 include: an ambient room temperature of about 60°-90° F.; an applied pressure of about 80-400 psi; a current density of about 10,000-30,000 amperes per square inch; a difference in electrical potential of about 2-6 volts; a linear speed of component layer materials and pre-bonded laminate material through the combination process of about 6-12 inches per minute; and a platen or flat bar size, when used in the combination process, of about 0.5-2.0 inches long, and a width about equal to the width of the pre-bonded laminate material (typically about 3-9 inches, but could also be at least 18 inches).

Other methods of pre-bonding may also be used in accordance with the method of the present invention. For example, any method of affixing together the two or more component layers including continuous resistance welding, spot welding and/or seam welding, wherein a weld is produced across less than substantially all of the surface area of the resulting pre-bonded laminate material, may be used as a pre-bonding method. Furthermore, high-pressure calendering (also known as “cold-bonding”), hydraulic or isostatic compression, isostatic compaction, adhesive bonding, and mechanical interweaving or interlocking are examples of suitable pre-bonding methods. The preferred embodiment of the method of the present invention includes a continuous or indexed resistance welding pre-bonding process, preferably employed with a simultaneous application of pressure such as may be achieved by calendering.

In an embodiment of the method of the invention, after the pre-bonded laminate material is produced, it is then sintered or diffusion bonded. Prior to the sintering or diffusion bonding, various optional processing steps, such as for example flattening, straightening, calendering, trimming, or tensioning, may be applied to the pre-bonded laminate material.

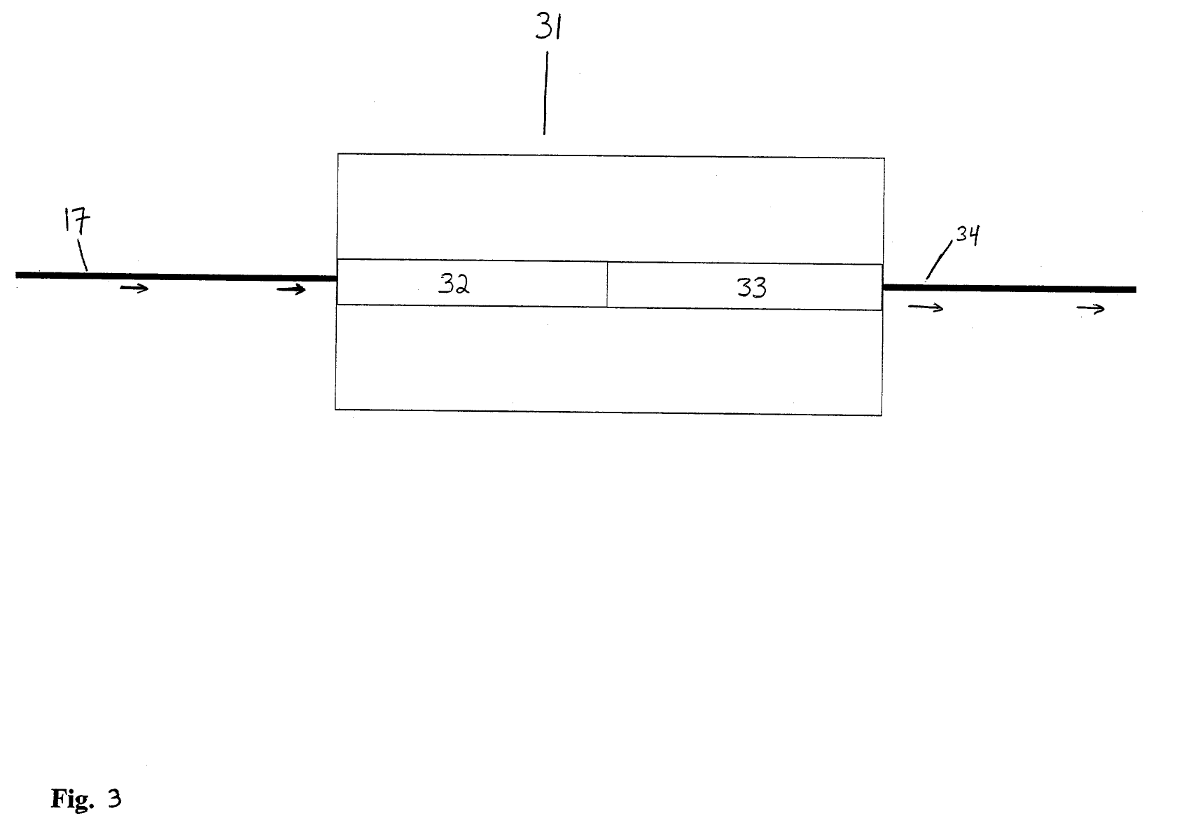

In this embodiment of the method of the invention, the sintering or diffusion bonding of the pre-bonded laminate material may be accomplished in several different ways. In one embodiment of the sintering method of the invention, an example of which is provided in FIG. 3, the sintering process is a continuous process. According to the example depicted in FIG. 3, the pre-bonded laminate material 17 is fed on a continuous linear basis through an open-ended sintering furnace 31, wherein it first travels through the furnace hot zone 32 before entering the furnace cooling zone 33. Exiting the furnace 31 is the continuous laminate strip material 34, which may then be rewound into a coil (not shown in FIG. 3) on the exit side of the furnace 31. This embodiment uses conventional gas atmosphere furnace equipment, typically with a pure dry hydrogen, dissociated ammonia, or exothermically generated gaseous atmosphere. In addition, various additional treatments may be employed between the unwinding of the feedstock rolls 1,2,3 and the final wind-up of the finished continuous laminate strip material 34, such as flattening, straightening, calendering, trimming, or tensioning. Although it is typically rendered unnecessary by virtue of the prior pre-bonding step, various additional means may also be employed to apply compressive force normal to the plane of the pre-bonded laminate material 17 as it travels through the furnace 31, such as ceramic or other calender rolls within the furnace hot zone 32, or the placement of weights on the moving pre-bonded laminate material 17.

In a further embodiment of the method of the invention, a continuous traveling stack of pre-bonded laminate material strips may be carried through the furnace on a moving belt, thereby permitting the sintering of many strips simultaneously. This embodiment would offer the advantage of helping to reduce the cost of the method of the invention per finished strip of continuous laminate material. As would be understood by one of ordinary skill in the art, and as is utilized in conventional batch sintering processes, a suitable means of separation is employed between the successively stacked strips of continuous laminate material.

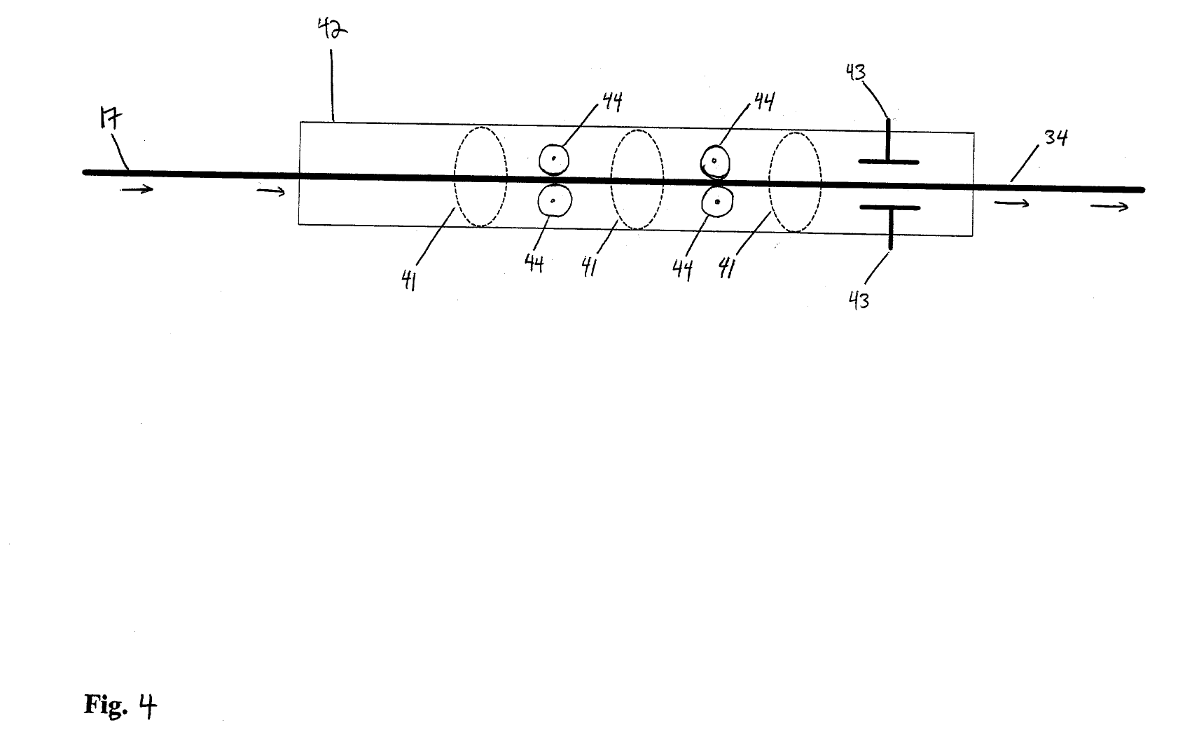

In another embodiment of the method of the invention, an example of which is shown in FIG. 4, the sintering process is a continuous process employing induction coils. According to this embodiment of the invention and as can be seen in FIG. 4, the pre-bonded laminate material 17 is fed on a continuous linear basis through one or more induction coils 41 in series, thereby producing the continuous laminate strip material 34 which may then be rewound into a coil (not shown in FIG. 4) on the exit side of the one or more induction coils 41. The induction coils 41 induce rapid heating in the pre-bonded laminate strip material 17 as it passes through them, by means of the well-known technology of electromagnetic induction heating. As would be understood by one of ordinary skill in the art, the one or more induction coils 41 may optionally be located within an enclosed chamber or “muffle” 42, within which a controlled gaseous atmosphere may be maintained to prevent oxidation and to provide the desired metallurgical properties.

In addition, within the optional muffle 42, a suitable means of applying pressure may optionally be included. For example, the pre-bonded laminate strip material 17 may be pressed between ceramic platens 43 or calender rolls 44, both of which are shown in FIG. 4. These optional ceramic platens 43 or calender rolls 44 may be located within the muffle 42 and within or between successive induction coils 41. The drive or control mechanisms for such ceramic platens 43 or calender rolls 44 would typically be outside the muffle 42, so as not to be subjected to elevated temperatures.

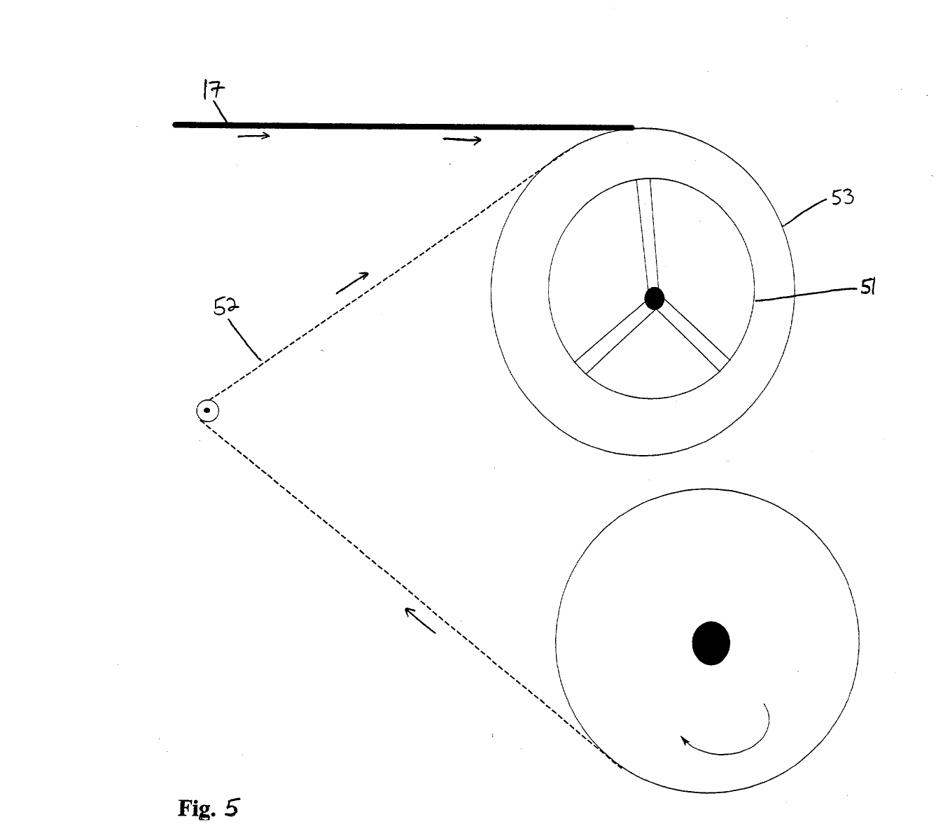

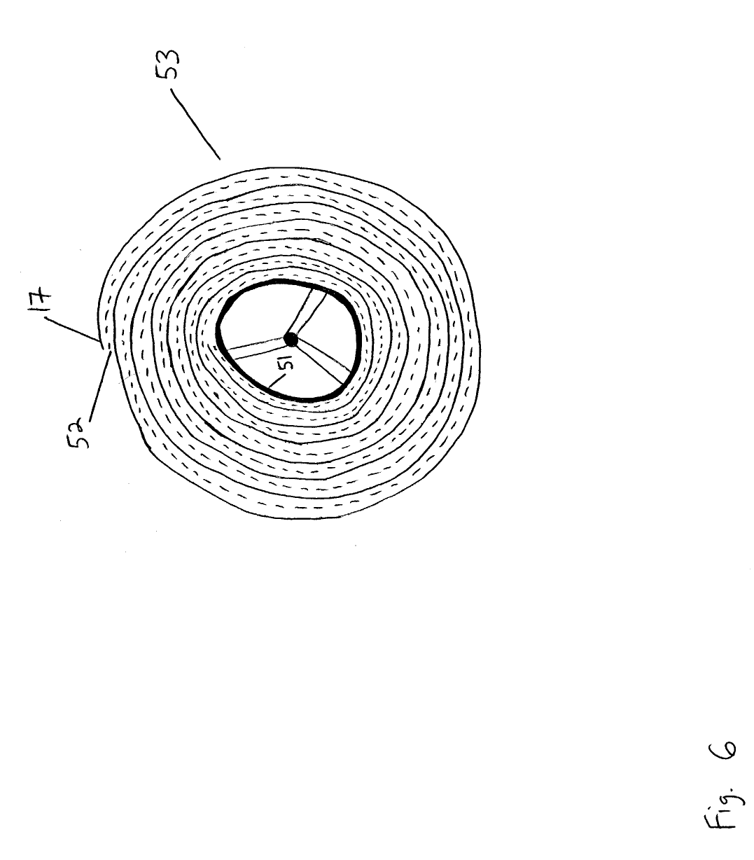

In a further embodiment of the method of the invention, the sintering process is a batch process. According to this embodiment of the invention, an example of which can be seen in FIG. 5, the pre-bonded laminate material 17 is wound up onto a core 51 with a suitable separator material 52 interleaved therein to form a coil 53. The separator material 52 is interleaved therein to provide separation of the pre-bonded laminate material 17 during sintering (such that the entire coil 53 does not sinter together, and thereby become nearly impossible to unwind later). Due to the prior pre-bonding process of the pre-bonded laminate material 17, the need for tension or radially applied compressive force is largely reduced. Furthermore, it is only necessary to wind the pre-bonded laminate material 17 and the separator material 52, and it is therefore easier to wind the coil 53 properly in preparation for batch sintering. FIG. 6 shows a schematic representation of the completely wound coil 53 which is ready for batch sintering, wherein the separator material 52 is interleaved between the pre-bonded laminate material 17.

As would be understood by one of ordinary skill in the art, this batch sintering process may be performed in accordance with known and established conventions and procedures which produce a secure diffusion bond at all points of contact within each layer, and between successive layers in the continuous laminate material. This embodiment of the sintering process may be accomplished in an atmosphere furnace, or preferably, in a vacuum furnace. Although this embodiment employs a batch process for the sintering process, it nevertheless results in the production of a continuous laminate strip material in coil form, which is securely bonded, yet remains clean, bright, ductile, and annealed, and is not metallurgically, mechanically or physically impaired in any way.

The present invention will now be described in detail with respect to showing how certain specific representative embodiments thereof can be made, the materials, apparatus and process steps being understood as examples that are intended to be illustrative only. In particular, the invention is not intended to be limited to the methods, materials, conditions, process parameters, apparatus and the like specifically recited herein.

### EXAMPLES

### Example 1

In an embodiment of the invention, a layer of AISI type 316L stainless steel plain square weave woven wire mesh having a mesh count of 100 warp and weft wires per inch, and a nominal wire diameter prior to weaving of 0.0045″ is pre-treated by calendering to a thickness of 0.007″ and then pre-bonded to a layer of 0.007″ thick solid metal foil of the same alloy using the preferred pre-bonding process that combines CRW and calendering pressure. The pre-bonded, continuous laminate material is then fed through an open-ended continuous linear strip sintering furnace to produce a continuous laminate strip material suitable for use in orthodontic appliances. This article has previously only been commercially available in discrete lengths of 24″ or less.

### Example 2

In another embodiment of the invention, three layers of AISI type 316L stainless steel plain square weave woven wire mesh, each layer being a “bolting cloth” of high open area percentage, and each layer having been pre-treated by degreasing and tensioning, are fed into the preferred pre-bonding process that combines CRW and calendering pressure, and then the pre-bonded, continuous laminate material is sintered to produce a continuous laminate strip material suitable for use as reactant flow field or coolant flow field porous media in electrochemical fuel cells. Without subsequent sintering of the pre-bonded laminate material, the bonds formed between adjacent layers within the pre-bonded laminate material remain imperfectly formed and metallurgically discontinuous, and therefore the pre-bonded laminate material displays an electrical resistivity that is not desirable in the intended application of electrochemical fuel cells. However, in accordance with this embodiment of the method of the present invention, the combination of pre-bonding and strip sintering produces a continuous metallurgical bond across the contact points between the layers of the continuous laminate strip material, which in turn allows for unimpeded electrical conductivity.

### Example 3

In a further embodiment of the invention, a layer of metal fiber media consisting of copped stainless steel fibers with a typical length of 0.25″ and a diameter of 12 microns, with an area density of 8 ounces per square yard, and a layer of twilled Dutch weave woven wire mesh having a mesh count of 200 warp and 1400 weft wires per inch, with nominal wire diameters of 0.0028″ and 0.0016″, respectively, all in AISI type 316L stainless steel, are pre-bonded and strip sintered to produce a continuous laminate strip material suitable for use as a high-performance depth filter for inkjet printer cartridges.

### Example 4

In yet another embodiment of the invention, a layer of plain Dutch weave wire mesh having warp and weft counts of twenty-four and one-hundred-ten wires per inch, respectively, with nominal wire diameters prior to weaving of 0.014″ and 0.010″, respectively; and a layer of plain square weave woven wire mesh having a mesh count of twenty wires per inch of nominal diameter 0.016″; and a further layer of plain square weave woven wire mesh having a mesh count of sixteen wires per inch of nominal diameter 0.023″; are laminated together as follows. First, the individual meshes are slit into coils 6″ wide and one-hundred feet in length. The coils are first calendered to overall thicknesses of 0.024″, 0.028″ and 0.035″ respectively, and then degreased. The three pre-calendered feedstock coils are pre-bonded using the preferred process that combines CRW and calendering pressure, thereby forming a pre-bonded laminate material, which is then wound onto a core under high tension using an interleaved separator medium comprising a plasma-sprayed and cured zirconium oxide coated strip of AISI type 304L stainless steel foil, using a winding apparatus known in the art and similar to that employed for making air bag windings. The tightly wound coil is then vacuum sintered using a process cycle similar to that used for conventional batch sintering of rectangular laminate panels, but without the normally applied isostatic pressure. The finished sintered coil is then unwound, calender flattened, trimmed, washed and dried, and is then ready for further fabrication into long-length spiral-wound and spiral-welded tubulation for use as sand control devices employed in a typical downhole well completion process for the production of oil and gas.

### Example 5

In this embodiment of the invention, the pre-bonded laminate material formed in Example 4 above is strip-fed through a continuous sintering furnace and rewound upon exiting the furnace, after calender-flattening and edge-trimming. Furthermore, additional layers may be added to the plain Dutch weave side of the laminate material, such as a drainage layer of plain square weave wire mesh having a mesh count of ten wires per inch with a wire diameter of 0.025″, and an additional layer of 16 gauge perforated, slotted, expanded, or otherwise foraminate sheet metal of the same alloy. In this embodiment of the invention, the alloy of all these layers is Carpenter Alloy 20Cb-3, rather than the AISI type 316L stainless steel which was used in previous examples.

While the present invention is described with respect to particular examples and preferred embodiments, it is understood that the present invention is not limited to these examples and embodiments. It will be apparent to anyone skilled in the art that numerous combinations of metallic layers of different types may be assembled and laminated in accordance with the present invention. A broad range of materials may thereby be produced, in many different metals and alloys, and with many different types and numbers of component layers, with or without various pre-treatments or post-treatments, all of which are within the scope of the present invention. For example, while some of these materials may be best produced by pre-bonded and strip sintering, others may be best produced by pre-bonding, winding, and coil sintering, while still others may be useful merely after pre-bonding without subsequent sintering. The present invention as claimed therefore includes variations from the particular examples and preferred embodiments described herein, as will be apparent to one of skill in the art.

What is claimed is:

1. A method of producing a continuous laminate strip material, said method comprising:
affixing together at least two layers to form a pre-bonded laminate material, wherein each of the layers comprises a continuous metallic material, and at least one of the layers is foraminate and permeable; and
sintering the pre-bonded laminate material to form a continuous laminate strip material.

2. The method of claim 1, wherein the affixing together comprises a simultaneous application to the at least two layers of a pressure and a flow of electrical current to produce a continuous resistance weld across substantially all of the surface area of the pre-bonded laminate material.

3. The method of claim 2, wherein the simultaneous application to the at least two layers of a pressure and a flow of electrical current is achieved by passing the at least two layers through at least one pair of rotating rolls.

4. The method of claim 2, wherein the simultaneous application to the at least two layers of a pressure and a flow of electrical current is achieved by intermittently moving the at least two layers through at least one pair of flat bars or at least one pair of platens.

5. The method of claim 2, wherein the sintering comprises continuously feeding the pre-bonded laminate material through an open-ended sintering furnace.

6. The method of claim 2, wherein the sintering comprises continuously feeding the pre-bonded laminate material through at least one induction coil.

7. The method of claim 2, further comprising:
after the affixing together and prior to the sintering, winding up the pre-bonded laminate material onto a core with a separator material interleaved therein,
wherein the sintering occurs in a vacuum furnace or an atmosphere batch furnace.

8. The method of claim 1, wherein the sintering comprises continuously feeding the pre-bonded laminate material through an open-ended sintering furnace.

9. The method of claim 1, wherein the sintering comprises continuously feeding the pre-bonded laminate material through at least one induction coil.

10. The method of claim 1, further comprising:
after the affixing together and prior to the sintering, winding up the pre-bonded laminate material onto a core with a separator material interleaved therein,
wherein the sintering occurs in a vacuum furnace or an atmosphere batch furnace.

11. The method of claim 1, wherein each of the layers is in the form of a woven wire mesh.

12. The method of claim 2, wherein each of the layers is in the form of a woven wire mesh.

13. The method of claim 1, wherein at least one of the layers is in the form of a woven wire mesh, and at least one of the layers is in the form of a metal foil or a metal strip.

14. The method of claim 13, wherein the metal foil or the metal strip is perforated, expanded, lanced, punched, drilled, etched, die cut, or otherwise cut.

15. The method of claim 2, wherein at least one of the layers is in the form of a woven wire mesh, and at least one of the layers is in the form of a metal foil or a metal strip.

16. The method of claim 15, wherein the metal foil or the metal strip is perforated, expanded, lanced, punched, drilled, etched, die cut, or otherwise cut.

17. The method of claim 1, further comprising:
flattening, straightening, calendering, trimming or tensioning the pre-bonded laminate material prior to sintering.

18. The method of claim 2, further comprising:
flattening, straightening, calendering, trimming or tensioning the pre-bonded laminate material prior to sintering.

19. The method of claim 1, wherein the affixing together comprises high-pressure calendering, cold bonding, hydraulic compression, isostatic compression, isostatic compaction, adhesive bonding, mechanical interweaving or mechanical interlocking.

20. The method of claim 1, wherein the affixing together comprises at least one of continuous resistance welding, spot welding and seam welding, wherein a weld is produced across less than substantially all of the surface area of the pre-bonded laminate material.

21. A continuous laminate strip material comprising:
at least one layer comprising a first continuous metallic material, wherein the at least one layer is foraminate and permeable; and
at least one additional layer comprising a second continuous metallic material;
wherein the at least one layer and the at least one additional layer are bonded together via continuous resistance welding, sintering, or a combination of continuous resistance welding and sintering.

22. The continuous laminate strip material of claim 21, further comprising:
a continuous metallurgical bond between the at least one layer and the at least one additional layer.

23. The continuous laminate strip material of claim 21, wherein the at least one layer and the at least one additional layer are in the form of a woven wire mesh.

24. The continuous laminate strip material of claim 21, wherein the at least one layer is in the form of a woven wire mesh, and the at least one additional layer is in the form of a metal foil or a metal strip.

25. The continuous laminate strip material of claim 24, wherein the metal foil or the metal strip is perforated, expanded, lanced, punched, drilled, etched, die cut, or otherwise cut.

26. The continuous laminate strip material of claim 21, wherein the first continuous metallic material and the second continuous metallic material comprise an austenitic stainless steel alloy.

27. The continuous laminate strip material of claim 26, wherein the austenitic stainless steel alloy is AISI type 316L stainless steel.

28. The continuous laminate strip material of claim 21, wherein the first continuous metallic material and the second continuous metallic material comprise an alloy of iron, nickel, cobalt, chromium, copper, aluminum or titanium.

29. The continuous laminate strip material of claim 28, wherein the alloy of iron, nickel, cobalt, chromium, copper, aluminum or titanium is Carpenter Alloy 20Cb-3.

30. The continuous laminate strip material of claim 28, wherein the alloy of iron, nickel, cobalt, chromium, copper, aluminum or titanium is Monel 400.
